(19) United States
(12) Patent Application Publication
(10) Pub. No.: US 2022/0417606 A1
(43) Pub. Date: Dec. 29, 2022

(54) CALENDAR FACILITY FOR OVER-THE-TOP (OTT) MEDIA SERVICE PLATFORMS

(71) Applicant: Avaya Management L.P., Durham, NC (US)

(72) Inventors: Pragati Dhumal, Pune (IN); Tanvi Sharma, Pune (IN); Navanath Navaskar, Pune (IN)

(21) Appl. No.: 17/356,357

(22) Filed: Jun. 23, 2021

(51) Int. Cl. H04N 21/482; H04N 21/45; H04N 21/431; H04N 21/475

(52) U.S. Cl. CPC H04N 21/4826; H04N 21/4532; H04N 21/431; H04N 21/4755

(57) ABSTRACT

Over-the-top (OTT) media management is provided to allow users to automatically populate one or more viewing periods with indicia of media content from one or more OTT media providers that is viewable to completion in the current viewing period. Additionally or alternatively, a plurality of indicia, associated with each of a plurality of media content, may populate one or more future viewing periods, such that the time a user has available for viewing content is associated with the best fitting content for a number of the plurality of future viewing periods to minimize the amount of free space and present all media content desired in one of the plurality of viewing periods. As a result, a user may setup their own timetable for viewing OTT media upon login and/or the OTT media provider suggesting content to view during a viewing period.

### COPYRIGHT NOTICE

A portion of the disclosure of this patent document contains material that is subject to copyright protection. The copyright owner has not objected to the facsimile reproduction by anyone of the patent document or the patent disclosure as it appears in the U.S. Patent and Trademark Office patent files or records, but otherwise reserves all copyright rights whatsoever.

### FIELD OF THE DISCLOSURE

The invention relates generally to systems and methods for media management and particularly to media management of an over-the-top (OTT) media service(s).

### BACKGROUND

Over-the-top (OTT) media services provide media content directly to users, most commonly via the internet, without inclusion of broadcast, cable, or satellite media delivery platforms. OTT media service platforms have become one of the more popular forms for viewing content and, for certain content, the essential services for viewing such content. Various types of streaming contents are available for viewing on these platforms. Whenever an OTT platform user logs in to the service, they are required to search and scroll through all of the available content as presented in order to select which content to they desire to view. This may comprise scrolling through a list of content, remembering what content(s) is a candidate for viewing, while continuing to scroll through additional listings. If no other media content supersedes the user's first choice, the user must then scroll back and search for their first choice in order to start viewing such content. This can often be time consuming.

### SUMMARY

A user may have time designated for viewing media content, such as a particular block of time during specific days of the week that are free or specifically allocated for viewing media content. This block of time may be relatively short, such as 15 to 30 minutes, and the user may wish to view media content that has a duration that substantially fills that time frame, such as a series episode or a short film. At other times, the user may have a longer period of time in which to view media content, such as several hours, and the user may wish to only consider movies, documentaries, or other longer duration media content. Searching for desired media content may be provided in addition to selecting media content, or contents, which match a user's preferences. However, the prior art only considers the user's content preferences but is silent to selecting, or further selecting, media content(s) that is viewable within a particular viewing period currently available to the user. That is, the time from now (i.e., the current time) until the end of a designated media viewing period, designated free time, or until another event or activity that requires the user to be unable to view, or continue viewing, media content. These events may be determined from a user's calendar records maintained in the data storage of a calendaring application.

When a user has a fixed period of time allocated as viewing period, especially when such time is relatively short, time spent identifying the desired media content to watch consumes the time that could be spent watching such desired media content. In consequence, the media content is unwatchable since the user's viewing period ends before the media content is complete. Additionally or alternatively, a particular media content or portion of a user's preferred media content may be desired for initial viewing with other suitable content, determined by residual time remaining in a viewing period.

In one example, John is usually free during the weekdays from 9 pm to 10 pm and wants to use this time for watching media content on the XYZ platform that he subscribed to. But each time he logs in to XYZ, he spends a considerable amount of time searching for the content he may want to watch. He might also search for reviews on the content to further impact his decision. He may then decide to look for some other options, consuming more time. Doing this everyday might lead to wasting a fruitful amount of time in which he could have spent watching a variety of contents that are smaller in duration, such as a few short films. However, with benefit of the embodiments described herein, John can be presented with only the contents that substantially fill his particular viewing period.

These and other needs are addressed by the various embodiments and configurations of the present invention. The present invention can provide a number of advantages depending on the particular configuration. These and other advantages will be apparent from the disclosure of the invention(s) contained herein.

In one embodiment, a calendar is added to an OTT media service platform or combination of platforms. The calendar may be specific to a user based on login. The user may allow the service to then select a full calendar of contents—based on time available for viewing and other content preferences. The user may pre-decide and set the content they may want to watch over the next week/month, and update the calendar with such information, saving the user's time that is typically wasted while scrolling and searching for desired content. As a further option, content that is set to be presented next for viewing may automatically start to play, such as upon logging in to the OTT service or a device connected to the OTT service.

In one embodiment, a system is disclosed, comprising: a network interface to a network; and a processor configured with machine-readable instructions maintained in a non-transitory memory that when read by the processor cause the processor to execute the machine-readable instructions; and wherein the processor rearranges a plurality of indicia on a display of a device, comprising: receiving a request to organize each indicia based on a specific criteria, wherein the specific criteria is a duration of a media content associated with each indicia; determining a duration of each media content when presented by the device; accessing a viewing period associated with a user; and automatically moving the indicia associated with the media content having the longest duration, but not greater than the viewing period, to a prioritized location on the display based on the duration of the associated media content.

In another embodiment, a method of organizing indicia of media content on a display by a processor is disclosed, comprising: receiving a request to organize each indicia based on a specific criteria, wherein the specific criteria is a duration of a media content associated with each indicia; determining a duration of each media content when presented by the device; accessing a viewing period associated with a user; and automatically moving the indicia associated with the media content having the longest duration, but not greater than the viewing period, to a prioritized location on the display based on the duration of the associated media content.

In another embodiment, a system for organizing media content indicia on a display of a device is disclosed, comprising: means to receive a request to organize each media content indicia based on a specific criteria, wherein the specific criteria is a duration of a media content associated with each media content indicia; means to determine a duration of each media content when presented by the device; means to access a viewing period associated with a user; and means to automatically move the media content indicia associated with the media content having the longest duration, but not greater than the viewing period, to a prioritized location on the display based on the duration of the associated media content.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a first graphical content in accordance with embodiments of the present disclosure;

FIG. 3 depicts second graphical content in accordance with embodiments of the present disclosure;

FIG. 4 depicts third graphical content in accordance with embodiments of the present disclosure;

FIG. 5 depicts a first process in accordance with embodiments of the present disclosure;

FIG. 6 depicts a second process in accordance with embodiments of the present disclosure; and

FIG. 7 depicts a second system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

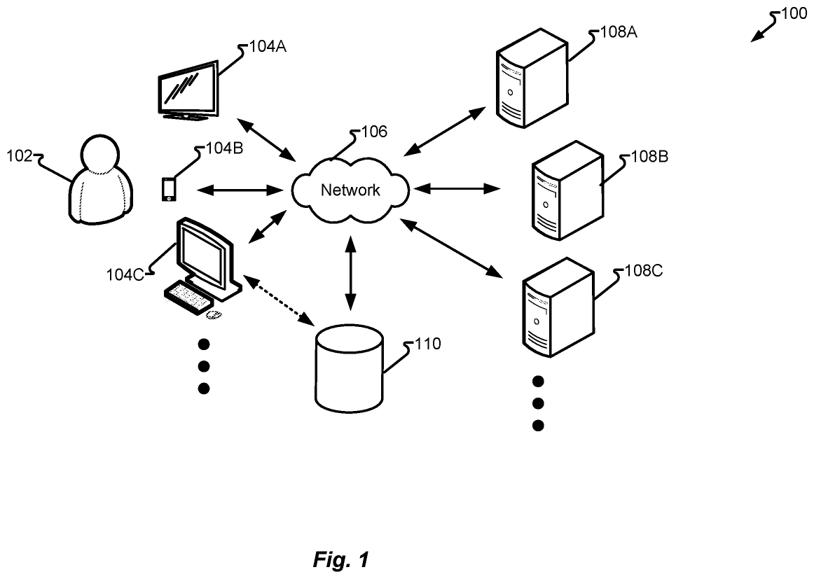

FIG. 1 depicts system 100 in accordance with embodiments of the present disclosure. In one embodiment, user 102 utilizes device 104 to view OTT media content, such as videos. Generally, the video will comprise a video portion and an audio portion. In some embodiments, the OTT media content may comprise video, without audio, and in other embodiments the OTT media content may be audio, without video (e.g., music, spoken books, internet-based radio, etc.).

Device 104 may comprise one or more devices each comprising a network interface to network 106 and a display operable to present graphical content of an application and OTT media content, as well as at least one input component to receive and process an input, such as from user 102 and at least one microprocessor (“processor”). The processor may execute machine-readable instructions, decode media content, such as OTT media content, for presentation on the display associated with device 104. Device 104 is variously embodied and may comprise television 104A, smart phone 104B, computer 104C, and/or other device(s). It should also be appreciated that, in other embodiments, device 104 comprises a plurality of interconnected devices, such as a first portion (e.g., network interface card/chip, router, switch, etc.) to communicate via network 106 with OTT media service 108 and a second portion to present the OTT media content, such as a primary or secondary display, for example a high-resolution display in communication with the first portion.

OTT media content may be obtained from OTT media service 108. It should be appreciated that OTT media service 108 may comprise a plurality of sources, such as OTT media service 108A-C, and/or other OTT media services, for example, YouTube, Tik Toc, Facebook, etc.

In one embodiment, device 104 accesses a calendar, such as a calendar record maintained in data storage 110 and/or other location, which may be integrated into or local to device 104 or remotely accessed via network 106 or other connection. The calendar may be a dedicated calendar utilized for scheduling viewing of OTT media content and/or another calendar (e.g., work, school, personal, etc.). For example, if another calendar is utilized for scheduling OTT media viewing, in whole or in part, the other calendar may report to a processor and/or application executing on device 104 the details of the user's scheduled activities or merely identify periods of time wherein user 102 has no scheduled activities (e.g., free time), and is thereby determined to be available to view OTT media content, and/or designated times specifically allocated for OTT media viewing.

In another embodiment, user 102 is presented with indicia of OTT media content in a default order. The default order may be an order determined by OTT media service 108 or an operator of OTT media service 108, a date order (e.g., newest first, newest last), a content attribute (e.g., favorites first), etc. A processor of device 104 may then receive a signal to reorganize the indicia of the OTT media content. In one embodiment, the signal is an explicit signal initiated by user 102 to organize the indicia. In another embodiment, the signal is created by an event, such as a login event to an OTT media player application utilized to view listings and/or play OTT media content. In other embodiments, the signal is in response to identification of an OTT media content for future viewing and in yet another embodiment, the signal is a time event, such as a periodic refresh. In response to the signal, the processor organizes the indicia of the OTT media content based on a specific criteria.

The specific criteria, in one embodiment, is a duration of the OTT media content as indicated or as determined to require when presented on device 104. For example, while an OTT media content may have an indicated duration of twenty minutes, additional time may be required to initiate, buffer, or process other overhead activities, to determine the actual duration as presented on device 104 is twenty-two minutes. Additionally, organizing the indicia of the OTT media content may comprise organizing the indicia based on the duration for one or more viewing periods, such as to best fill (e.g., least amount of unused time) the one or more viewing periods. For example, if user 102 has a calendar event having a viewing period (e.g., free time or designated OTT viewing time) of thirty minutes, indicia of OTT media content may be organized such that one OTT media content having a twenty-eight-minute duration is placed in a high priority location over a second OTT media content having a twenty-one-minute duration, and thereby have the least amount of unused time for the viewing period. OTT media content that has a duration longer than the one or more viewing periods, such as for an upcoming day, week, month, etc., may require user 102 to authorize splitting the scheduling of the OTT media content into two or more segments and then placing the two or more segments, in chronological order, into separate viewing periods or otherwise scheduling or excluding such OTT media content.

In another embodiment, such as upon the occurrence of a viewing period, a processor of device 104 may present indicia of the associated OTT media content that is in the priority location and/or automatically initiate playback of the OTT media content associated with the indicia in the priority location.

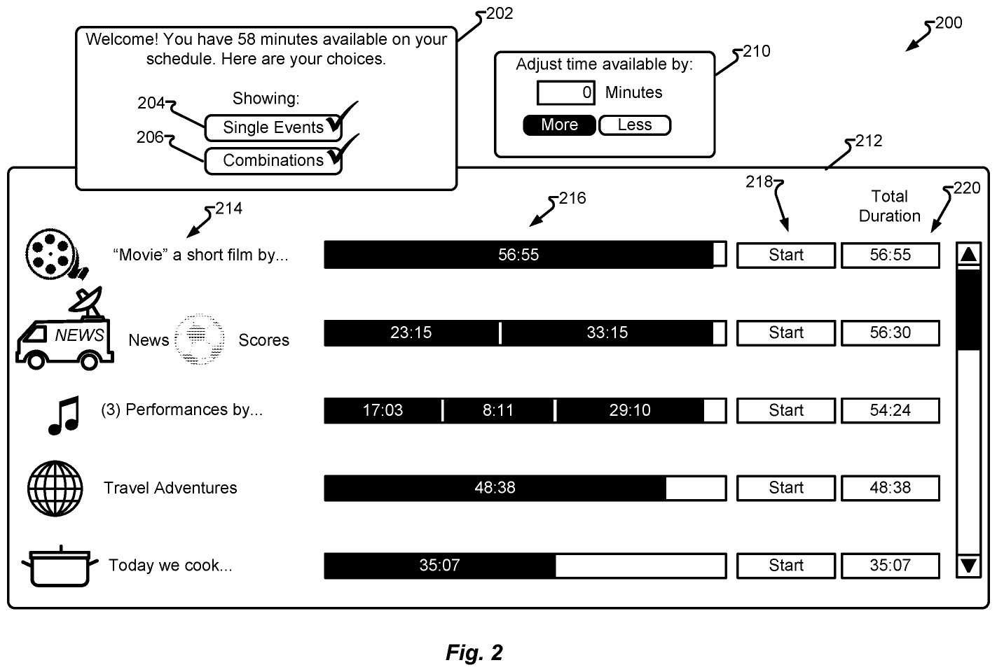

FIG. 2 depicts graphical content 200 in accordance with embodiments of the present disclosure. In one embodiment, graphical content 200 comprises the output of an application executed by device 104 and presented on a display of device 104 and/or a display in communication with device 104. Graphical content 200 may comprise welcome dialog box 202.

In one embodiment, welcome dialog box 202 is present on launching of an OTT viewing application executing on device 104, which may coincide with a viewing period. For example, user 102 may log into the OTT application at the start of a scheduled sixty-minute viewing period and the time from “now” until the end of the viewing period, as illustrated, is fifty-eight minutes. Additionally or alternatively, status button 204 may indicate that single events (e.g., indicia of unitary OTT media content) is being presented and/or status button 206 may indicate that combinations (e.g., two or more indicia of OTT media contents) are being presented. Status button 204 or status button 206 may be unselected and cause dialog 212 to only display combinations or single events, respectively.

Dialog 212 presents indicia of OTT media content which may include descriptor 214, which may comprise an icon, title, thumbnail, description, and/or other attribute; time bar 216 may present the presentation duration and/or unused presentation duration; start 218 causes a processor of device 104 to launch the associated OTT media content; and duration 220 presents the duration—which may be as-reported by the OTT media content provider or as required for viewing on device 104, such as to account for buffering or other overhead. Duration 220 may reflect the duration of a combination of OTT media content. Here to, the duration of the combination may be as reported and/or to account for overhead or other factors to determine an actually viewing time on device 104.

Here, the top portion of dialog 212 is a high-priority location as the listing therein may comprise a nearly limitless number of indicia for OTT media content from a single OTT media service 108 or a plurality of OTT media services 108. Accordingly, device 104 may move indicia of OTT media content to a priority location based on duration of the associated OTT media content that best fills, without exceeding the viewing period.

As a further option, user 102 may need to modify the duration of the current viewing period. Accordingly, adjustment dialog 210 receives inputs to add or remove time from the current viewing period. In response to an adjustment, a processor of device 104 reorganizes the contents in dialog 212 so as to provide indicia of the OTT media content having the longest, but not exceeding, duration for the adjusted duration of the current viewing period.

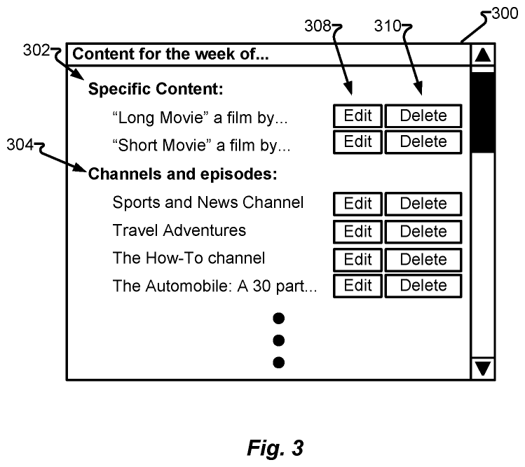

FIG. 3 depicts graphical content 300 in accordance with embodiments of the present disclosure. In one embodiment, graphical content 300 comprises the output of an application executed by device 104 and presented on a display of device 104 and/or a display in communication with device 104. Graphical content 300 may comprise a current set of identifiers for OTT media content to be automatically added to a schedule for user 102 for one or more future viewing periods.

In one embodiment, graphical content 300 comprises specific content 302, such as to identify a particular OTT media content. In other embodiment, graphical content 300 comprises category 304 comprising identifiers sources within a particular OTT media service 108, such as a channel, content provider, attributes, etc. Edit option 308 allows user 102 to edit the rules associated with a particular indicia of OTT media content. For example, editing an entry within specific content 302 may allow user 102 to authorize the specific content to be split into segments for viewing in different, non-contiguous, viewing periods. Editing an entry within category 304 may alter rules (e.g., all OTT media content versus only new, only OTT media content that has been uploaded within the previous six hours—such as weather, etc.) and/or prioritizations (e.g., prioritize news having “my city” in the title, etc.). Delete button 310 allows the content to be excluded from consideration and/or removed from graphical content 300.

With benefit of a data record, such as maintained in data storage 110, in response to the inputs and/or values presented in graphical content 300, a processor of device 104 may schedule OTT media content, for future viewing in one or more viewing periods, that match the rules and/or attributes presented in graphical content 300.

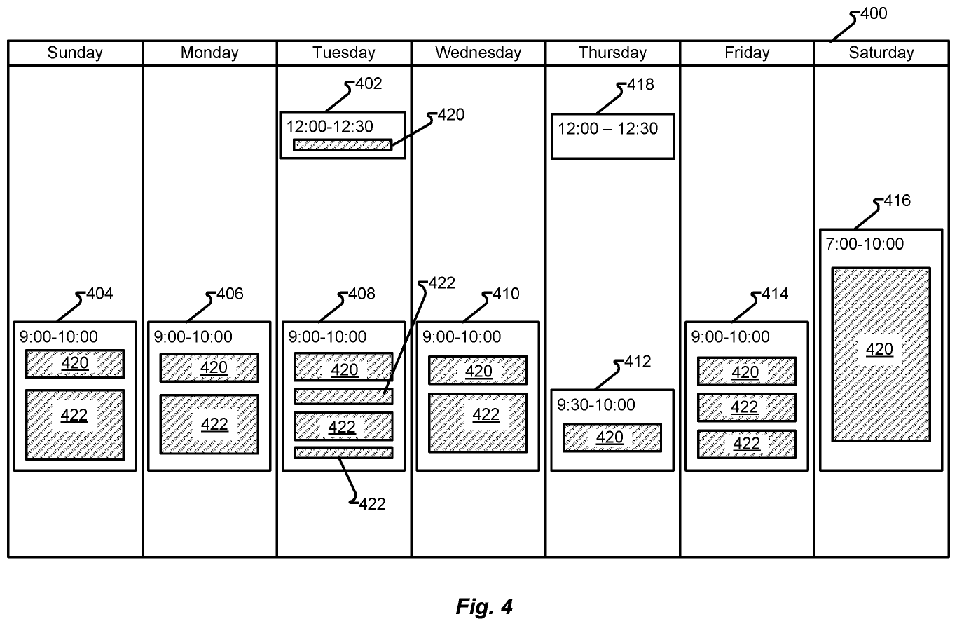

FIG. 4 depicts graphical content 400 in accordance with embodiments of the present disclosure. In one embodiment, graphical content 400 comprises the output of an application executed by device 104 and presented on a display of device 104 and/or a display in communication with device 104. Graphical content 400 may comprise a display of a period of time occurring, in whole or in part, in the future, such as to graphically represent calendar records maintained in data storage 110.

Graphical content 400 comprises viewing periods 402-418 for a period of time (e.g., one week). In response to a signal to organize indicia of OTT media content, the processor determines unitary or combinations of OTT media content having a duration to best fill (e.g., least amount of residual unallocated time) but not exceeding any one of viewing periods 402-418. Accordingly, indicia of the OTT media content is organized such that one, if unitary, or plurality, if a combination, of OTT media content duration is placed in a high-priority location(s) 420, such as to coincide with an upper-most portion of each viewing period 402-418. Indicia of OTT media content that is not placed in high-priority location(s) 420 is then placed in secondary location 422. Additionally or optionally, the organization of indicia within secondary locations 422 may further be provided in duration order of the associated OTT media content, series of related content, oldest to newest, newest to oldest, and/or other order. Not every viewing period may have an associated indicia of OTT media content, such as indicated by viewing period 418.

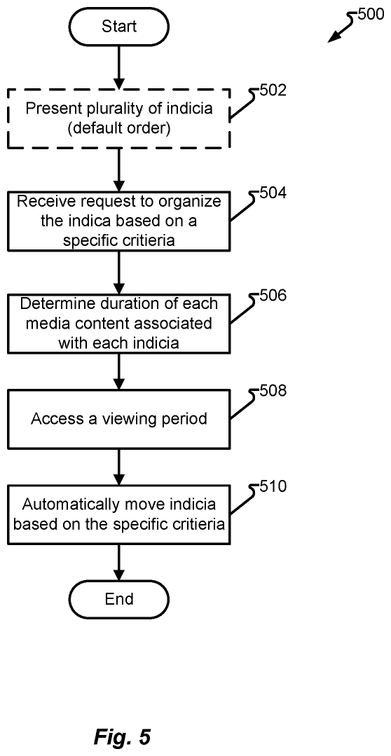

FIG. 5 depicts process 500 in accordance with embodiments of the present disclosure. Process 500 may be embodied as machine-readable instructions that when read by a processor, such as one or more processors of device 104, cause the processor to execute the machine-readable instructions and perform the steps of process 500. In another embodiment, process 500 may be executed by a processor of OTT media service 108. Generally, and in one embodiment, process 500 organizes indicia of OTT media content based on a specific criteria for a single viewing period, such as a current viewing period (e.g., starting at the current time and ending at a previously determined subsequent time).

In one embodiment, process 500 begins and optionally, step 502 presents a plurality of indicia of OTT media content in a default order and/or location. The default order/location may be determined by OTT media service 108 and/or other process. Step 504 receives a request to organize the indicia based on the specific criteria. The specific criteria may be a duration of one, or optionally a plurality, of OTT media content corresponding to one, or a plurality, of indicia of OTT media content. Step 506 determines a duration associated with each OTT media content. The duration may be a reported duration and/or a duration as required for presentation by a particular device, such as device 104, which may account for buffering and/or other overhead.

Next, step 508 accesses a viewing period, such as from a calendar record maintained in data storage 110 and/or other source. Step 510 automatically moves the indicia of the OTT media content that satisfies, or best satisfies, the specific criteria to a priority location in a display of device 104 based on the specific criteria. In a further embodiment, step 510 further moves indicia of the OTT media content that next satisfies the specific criteria to a second highest priority location. As can be appreciated, subsequent best matches to the specific criteria may be moved to subsequent priority locations of device 104.

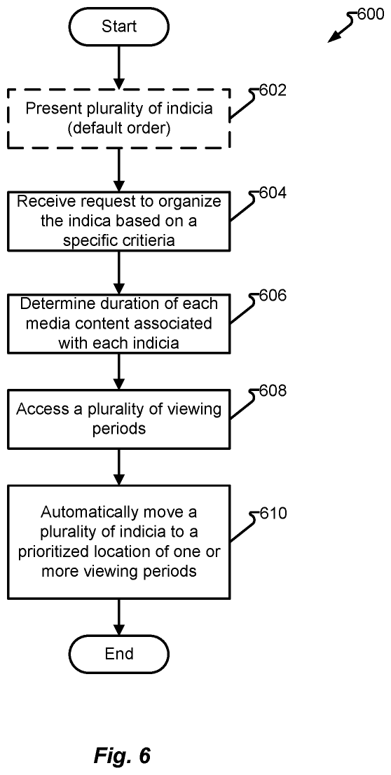

FIG. 6 depicts process 600 in accordance with embodiments of the present disclosure. Process 600 may be embodied as machine-readable instructions that when read by a processor, such as one or more processors of device 104, cause the processor to execute the machine-readable instructions and perform the steps of process 600. Generally, and in one embodiment, process 600 organizes indicia of OTT media content based on a specific criteria for a plurality of viewing period, such as future viewing periods.

In one embodiment, process 600 begins and optionally, step 602 presents a plurality of indicia of OTT media content in a default order and/or location. The default order/location may be determined by OTT media service 108 and/or other process. Step 604 receives a request to organize the indicia based on the specific criteria. The specific criteria may be a duration of one OTT media content and/or the duration of a combination(s) of a plurality of OTT media contents. Step 606 determines a duration associated with each OTT media content. The duration may be a reported duration and/or a duration as required for presentation by a particular device, such as device 104, which may account for buffering and/or other overhead.

Next, step 608 accesses viewing periods for each of a plurality of viewing periods, such as from a calendar record maintained in data storage 110 and/or other source. Step 610 automatically moves the indicia of the OTT media content that satisfies, or best satisfies, the specific criteria to a priority location in a display of device 104 based on the specific criteria for each of one or more of the viewing periods. In a further embodiment, step 610 further moves indicia of the OTT media content that next satisfies the specific criteria to a second highest priority location for the one or more viewing periods. As can be appreciated, subsequent best matches to the specific criteria may be moved to subsequent priority locations for one or more viewing periods presented on device 104.

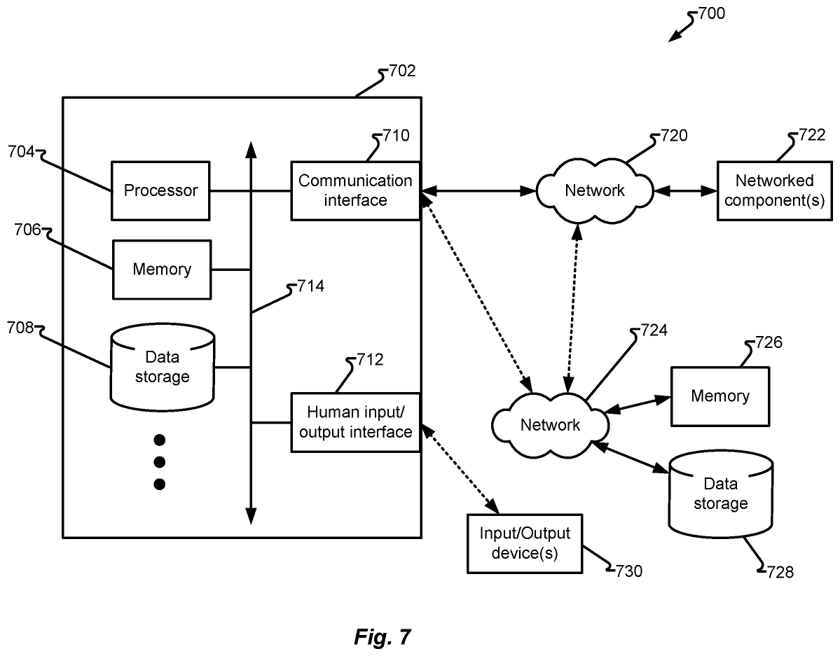

FIG. 7 depicts device 702 in system 700 in accordance with embodiments of the present disclosure. In one embodiment, device 104 may be embodied, in whole or in part, as device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices). Processor 704 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize memory 706 and/or data storage 708 for the storage of accessible data, such as instructions, values, etc. Communication interface 710 facilitates communication with components, such as processor 704 via bus 714 with components not accessible via bus 714. Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, communication interface 710 may comprise, or be comprised by, human input/output interface 712. Communication interface 710 may be configured to communicate directly with a networked component or utilize one or more networks, such as network 720 and/or network 724.

Network 106 may be embodied, in whole or in part, as network 720. Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.)

Additionally or alternatively, one or more other networks may be utilized. For example, network 724 may represent a second network, which may facilitate communication with components utilized by device 702. For example, network 724 may be an internal network to a business entity or other organization, whereby components are trusted (or at least more so) that networked components 722, which may be connected to network 720 comprising a public network (e.g., Internet) that may not be as trusted.

Components attached to network 724 may include memory 726, data storage 728, input/output device(s) 730, and/or other components that may be accessible to processor 704. For example, memory 726 and/or data storage 728 may supplement or supplant memory 706 and/or data storage 708 entirely or for a particular task or purpose. For example, memory 726 and/or data storage 728 may be an external data repository (e.g., server farm, array, “cloud,” etc.) and allow device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720. Each of memory 706, data storage 708, memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, switch, port, or other communication component such that a particular output of processor 704 enables (or disables) input/output device 730, which may be associated with network 720 and/or network 724, to allow (or disallow) communications between two or more nodes on network 720 and/or network 724. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface to a network; and
a processor configured with machine-readable instructions maintained in a non-transitory memory that when read by the processor cause the processor to execute the machine-readable instructions; and
wherein the processor rearranges a plurality of indicia on a display of a device, comprising:
receiving a request to organize each indicia based on a specific criteria, wherein the specific criteria is a duration of a media content associated with each indicia;
determining a duration of each media content when presented by the device;
accessing a viewing period associated with a user; and
automatically moving the indicia associated with the media content having the longest duration, but not greater than the viewing period, to a prioritized location on the display based on the duration of the associated media content.

2. The system of claim 1, wherein the processor rearranges the plurality of indicia on the display of the device, upon receiving the request to organize each indicia based on the specific criteria comprising:
determining the duration of each media content when presented by the device, further comprising determining a duration of combinations of pluralities of each media content when presented by the device; and
automatically moving the indicia associated with the combination of the plurality of media contents having the longest duration, but not greater than the viewing period, to the prioritized location on the display based on the duration of the associated combination of the plurality of each media content.

3. The system of claim 1, wherein each media content is selected from a pool of media content, the selection matching an entry in a user preference record.

4. The system of claim 1, wherein the viewing period is determined by the processor accessing a calendar record comprising a next event for the user and determining the viewing period as the current time until the next event.

5. The system of claim 1, wherein the viewing period is determined by the processor accessing a calendar record comprising an allocated media viewing timeframe for the user and determining the viewing period as the current time until the end of the allocated media viewing timeframe.

6. The system of claim 1, wherein the processor automatically initiates playback of the media content associated with the indicia located at the prioritized location.

7. The system of claim 1, wherein the viewing period has a start time occurring in the future.

8. The system of claim 1, wherein the processor in response to receiving the request to organize each indicia based on the specific criteria, performs:
accessing the viewing period comprising a plurality of viewing periods, wherein each of the plurality of viewing periods are distinct and do not overlap any other of the plurality of viewing periods; and
for each of two or more of the plurality of viewing periods, automatically moving the indicia associated with the media content having the longest duration, but not greater than the viewing period, to a prioritized location on the display for at least one of the two or more of the plurality of viewing periods, based on the duration of the associated media content.

9. The system of claim 8, wherein the processor further performs selecting a next longest media content from the plurality of media content and automatically moving the indicia associated with the next longest media content to a next prioritized location on the display for at least one of the two or more of the plurality of viewing periods, based on the duration of the next longest media content.

10. The system of claim 1, wherein the media content is accessed by one or more over-the-top media services providers accessible to the device via a network.

11. A method of organizing indicia of media content on a display by a processor, comprising:
receiving a request to organize each indicia based on a specific criteria, wherein the specific criteria is a duration of a media content associated with each indicia;
determining a duration of each media content when presented by the device;
accessing a viewing period associated with a user; and
automatically moving the indicia associated with the media content having the longest duration, but not greater than the viewing period, to a prioritized location on the display based on the duration of the associated media content.

12. The method of claim 11, wherein:
rearranges the plurality of indicia on the display of the device, upon receiving the request to organize each indicia based on the specific criteria comprising:
determining the duration of each media content when presented by the device, further comprising determining a duration of combinations of pluralities of each media content when presented by the device; and
automatically moving the indicia associated with the combination of the plurality of media contents having the longest duration, but not greater than the viewing period, to the prioritized location on the display based on the duration of the associated combination of the plurality of each media content.

13. The method of claim 11, wherein each media content is selected from a pool of media content, the selection matching an entry in a user preference record.

14. The method of claim 11, wherein determining the viewing period is further determined by accessing a calendar record comprising a next event for the user and determining the viewing period as the current time until the next event.

15. The method of claim 11, wherein determining the viewing period is determined by accessing a calendar record comprising an allocated media viewing timeframe for the user and determining the viewing period as the current time until the end of the allocated media viewing timeframe.

16. The method of claim 11, further comprising automatically initiating playback of the media content having the associated indicia located at the prioritized location.

17. The method of claim 11, wherein the viewing period has a start time occurring in the future.

18. The method of claim 11, wherein:
accessing the viewing period further comprises accessing a plurality of viewing periods, wherein each of the plurality of viewing periods are distinct and do not overlap any other of the plurality of viewing periods; and
wherein, for each of two or more of the plurality of viewing periods, automatically moving the indicia associated with the media content having the longest duration, but not greater than the viewing period, to a prioritized location on the display for at least one of the two or more of the plurality of viewing periods, based on the duration of the associated media content.

19. The method of claim 18, further comprising selecting a next longest media content from the plurality of media content and automatically moving the indicia associated with the next longest media content to a next prioritized location on the display for at least one of the two or more of the plurality of viewing periods, based on the duration of the next longest media content.

20. A system for organizing media content indicia on a display of a device, comprising:
means to receive a request to organize each media content indicia based on a specific criteria, wherein the specific criteria is a duration of a media content associated with each media content indicia;
means to determine a duration of each media content when presented by the device;
means to access a viewing period associated with a user; and
means to automatically move the media content indicia associated with the media content having the longest duration, but not greater than the viewing period, to a prioritized location on the display based on the duration of the associated media content.
